(19) United States
(12) Patent Application Publication
(10) Pub. No.: US 2003/0105885 A1
(43) Pub. Date: Jun. 5, 2003

(54) Capturing command execution status

(75) Inventor: James M. McArdle, Austin, TX (US)

Correspondence Address: Frank C. Nicholas, CARDINAL LAW GROUP, Suite 2000, 1603 Orrington Avenue, Evanston, IL, 60201, US

(73) Assignee: International Business Machines Corporation, Armonk, NY

(21) Appl. No.: 10/004,924

(22) Filed: Dec. 5, 2001

(51) Int. Cl. G06F 9/00; G06F 9/46

(52) U.S. Cl. 709/320

(57) ABSTRACT

The invention provides a method of communication between an application program and a command script. The method comprises the use of a log file to store the return code of the last executed command. The log file provides the application program with a means of verifying the success or failure of the commands in a command script.

### RELATED APPLICATIONS

This application relates to U.S. application (IBM Dkt. No. AUS820011291) entitled “Command Script Instrumentation for Logging Command Execution and the Protection of Sensitive Information,” filed concurrently herewith.

### FIELD OF THE INVENTION

This invention relates to application programs prompting the execution of command scripts. More specifically, the invention relates to communicating the success or failure of command scripts back to the calling application program.

### BACKGROUND OF THE INVENTION

Application programs often launch operating system level command scripts, which may contain any number of commands that must be successfully executed in their entirety to achieve the script's desired end. Such scripts are useful, in that they allow for powerful low-level system calls, but the available commands and breadth of functionality are relatively limited.

A frequent problem is that the command processor does not pass back to the application program information pertaining to the success or failure status of the most recently executed command. And as a result, the application program that called the script may not know whether the command script has been executed successfully or at all.

Developers may be able to design application programs that verify successful execution of commands, such as moving or creating files, but this solution requires a new verification routine to be implemented for each command script.

It would be desirable to have a system and method that tracks the success or failure status of a command, and communicates that status by means of a command script back to the application program that prompted its execution.

### BRIEF SUMMARY OF THE INVENTION

One aspect of the invention provides a method of communicating between an application program and a command script. The method may comprise the use of a log file to store the return code of the last executed command. The log file may be stored on hard disk, RAM disk, or any location recognized as accessible by the command processor. The return code stored in the log file may provide the application program with a method for verifying the success or failure of each command in a command script.

Another aspect of the invention provides a system of communicating between an application program and a command script. The system may comprise means of using a log file to store the return code of the last executed command. These means may allow the log file to be stored on hard disk, RAM disk, or any location recognized as accessible by the command processor. The return code stored in the log file provides the application program with a means for verifying the success or failure of each command script.

Another aspect of the invention may provide a computer readable medium storing a computer program. The computer readable medium may comprise computer readable code for communicating between an application program and a command script. The computer readable code makes use of a log file to store a return code of the last executed command. The computer readable code may specify that the log file be stored on a hard disk, RAM disk, or any location recognized as accessible by the command processor. Computer readable code may access the return code stored in the log file providing the application program with the success or failure status of each command script.

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a block diagram illustrating one embodiment of the computer, network, and file-based system in accordance with the present invention; and

FIG. 2 is a flowchart representation of one embodiment of the interaction between an application program and command script in accordance with the present invention.

### DETAILED DESCRIPTION OF THE PRESENTLY PREFERRED EMBODIMENTS

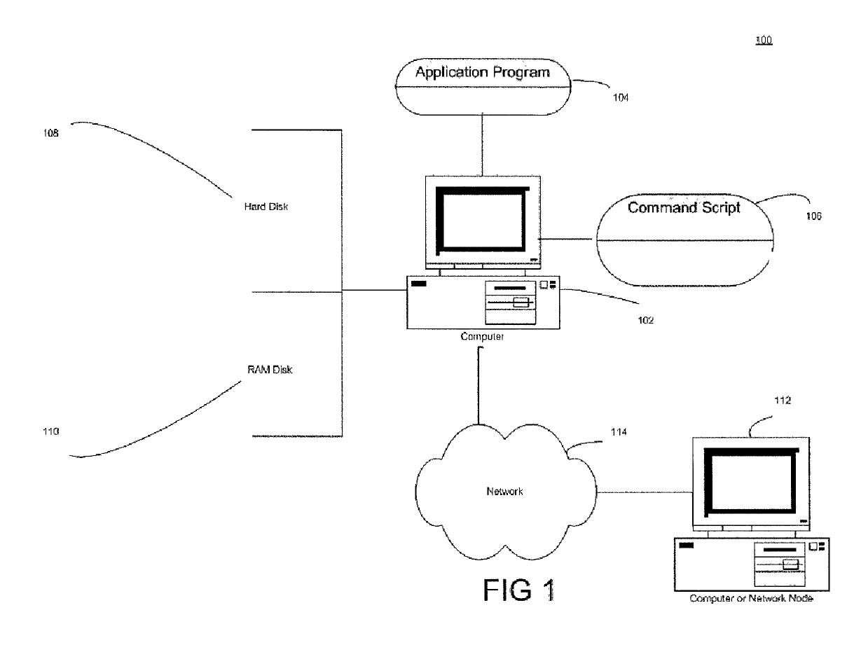

In FIG. 1, a network-based system 100 illustrates one embodiment of the present invention. The invention relates to the communication between application program 104 and command script 106 that run on a command processor of local computer 102. In one embodiment of the invention, application program 104 may require that certain commands in command script 106 be completed successfully before the application program's operation continues. In another embodiment of the invention, application program 104 may provide a means of interaction with an end user. When an error occurs in command script 106, application program 104 may require information about that error, so that it may be reported to the end user. The execution of each command in command script 106 may generate a return code, which is a value returned to the command processor following execution of a command. This return code of a command in command script 106 may be required in application program 104. Communication from command script 106 to program application 104 is made possible through the use of a return code file, which is a commonly accessible file that may store one or more return codes. A return code file, which is a commonly accessible file storing one or more return codes, may facilitate communication from command script 106 to program application 104. In one embodiment of the invention, the return code file may reside on the hard disk 108 of local computer 102. In another embodiment the return code file may reside on RAM Disk 110 on the local computer 102. A computer or other network node 112 on a network 114 may also be used to store the return code file. The return code file may be located anywhere recognized both by the command processor executing the command script 106 and application program 104. The return code file may be created by application program 104 or by command script 106. In one embodiment, command script 106 may create then return code file. Before accessing return code file, application program 104 may check for its existence, indicating that command script 106 has executed.

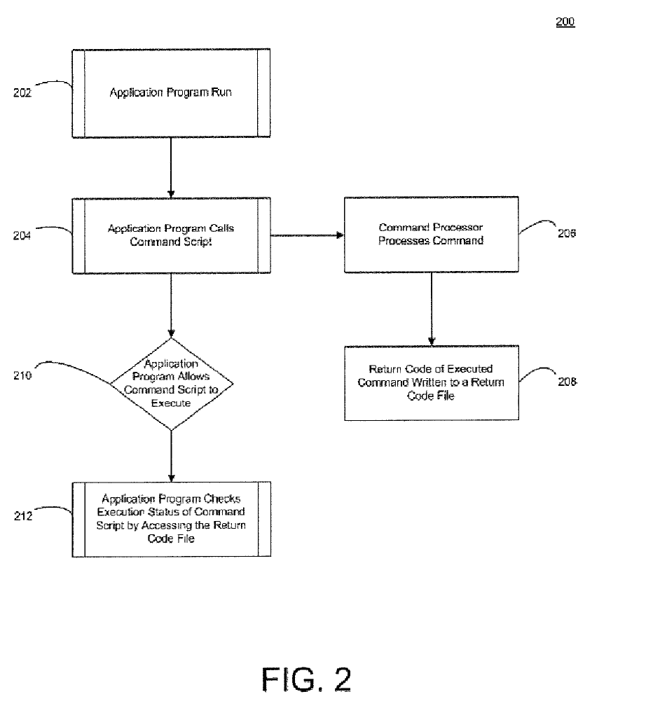

FIG. 2 is a flowchart that illustrates communication between application program 104 and command script 106. At some point in the running of an application program (BLOCK 202), the program may prompt the execution of a command script (BLOCK 204). In one embodiment, application program may create or define a return code file that may be used by the command script, prior to prompting the execution of the command script (BLOCK 204). The return code file created or defined by the application program may be stored on local hard disk 108, local RAM disk 110, network location 112, or some other location recognized by a command processor running the command script. After the application program prompts the execution of the command script (BLOCK 204), the command script may begin processing the commands contained therein (BLOCK 206). In one embodiment, the command script may create or define the return code file that may be used in the command script. The return code file created by the command script may be held on local hard disk 108, local RAM disk 110, network location 112, or some other location recognized by a command processor running the command script. When the commands in the command script are executed, the command script may write the return code of the executed command to the return code file (BLOCK 208). The application program may pause to allow time for the command script to execute (BLOCK 210). The application program may then check the execution status of the command script by accessing the return code file (BLOCK 212). In one embodiment, when the command script is responsible for creating the return code file, the application program may check for the existence of the return code file prior to accessing it (BLOCK 212). Existence of the return code file may then indicate that an execution of the command script was attempted, and that the script has executed at least to the point of creating the return code file. After accessing the return code file (BLOCK 212) the application program may proceed in whatever manner is deemed appropriate given the execution status of the command script, which was communicated by means and system already described.

The above-described methods and implementation of logging command execution in a command script are exemplary methods illustrating one possible approach for logging command execution in a command script. The actual implementation may vary from the method discussed. Moreover, various other improvements and modifications to this invention may be evident to those skilled in the art, and those improvements and modifications fall within the scope of this invention as set forth below.

While embodiments of the invention disclosed herein are presently preferred, various changes and modifications can be made without departing from the spirit and scope of the invention. The scope of the invention is indicated in the appended claims, and all changes that come within the meaning and range of equivalents are intended to be embraced therein.

1. A method of providing command execution status of a command script to an application program, comprising:
creating a return code file;
storing a return code of at least one command of a command script in the return code file; and
accessing the stored return code from an application program.

2. The method of claim 1 wherein the return code file is created by the command script.

3. The method of claim 2 further comprising verifying the existence of the return code file, prior to accessing the stored return code.

4. The method of claim 1 wherein the return code is created by the application program.

5. The method of claim 1 further comprising prompting execution of the command script from the application program.

6. The method of claim 1 wherein the return code file comprises a file stored on a hard disk.

7. The method of claim 1 wherein the return code file comprises a file stored on a RAM disk.

8. The method of claim 1 wherein the return code file comprises a file stored in any location recognized as accessible by the command processor.

9. A system of providing command execution status of a command script to an application program, comprising:
means for creating a return code file;
means for storing a return code of at least one command of a command script in the return code file; and
means for accessing the stored return code from an application program.

10. The system of claim 9 further comprising means of verifying the existence of the return code file, prior to accessing the stored return code.

11. The system of claim 9 further comprising means of prompting the execution of the command script from the application program.

12. A computer readable medium storing a computer program that provides command execution status of a command script to an application program, comprising:
computer readable code for creating a return code file;
computer readable code for storing a return code of at least one command of a command script in the return code file; and
computer readable code for accessing the stored return code from an application program.

13. The computer readable medium of claim 12 wherein the return code file is created by the command script.

14. The computer readable medium of claim 13 further comprising computer readable code for verifying the existence of the return code file, prior to accessing the stored return code.

15. The computer readable medium of claim 12 wherein the return code is created by the application program.

16. The computer readable medium of claim 12 further comprising computer readable code for prompting execution of the command script from the application program.

17. The computer readable medium of claim 12 wherein the return code file comprises a file stored on a hard disk.

18. The computer readable medium of claim 12 wherein the return code file comprises a file stored on a RAM disk.

19. The computer readable medium of claim 12 wherein the return code file comprises a file stored in any location recognized as accessible by the command processor.
